(19) United States
(12) Patent Application Publication
(10) Pub. No.: US 2024/0193494 A1
(43) Pub. Date: Jun. 13, 2024

(54) PAYMENT MANAGEMENT AND VALIDATION SERVICE EXTENSION FOR RESERVATION BOOKING SERVICES

(71) Applicant: SELFBOOK, INC., West Hollywood, CA (US)

(72) Inventors: Khalid MENIRI, Beverly Hills, CA (US); Mohammed Ilyas DJEDDOU, Brooklyn, NY (US)

(21) Appl. No.: 18/531,927

(22) Filed: Dec. 7, 2023

Related U.S. Application Data
(60) Provisional application No. 63/430,800, filed on Dec. 7, 2022.

(51) Int. Cl. G06Q 10/02; G06Q 20/40

(52) U.S. Cl. CPC G06Q 10/02; G06Q 20/401

(57) ABSTRACT

Methods and systems for improved payment information processing for reservation systems are provided. In one aspect, a first computing device may receive payment information for a reservation and may determine a payment token based on the payment information. The first computing device may transmit the payment token to a reservation booking system. A second computing device may receive, from the reservation booking system, a first application programming interface (API) request to process the reservation with a central reservation service (CRSThe first API request may receive at a first API. The second computing device may determine, based on the first API request, a second API request that includes at least a portion of the payment information and may transmit the second API request to a second API associated with the CRS. For example, the second API request may be transmitted from the first API to the second API.

### CROSS REFERENCE TO RELATED APPLICATIONS

The present application claims the benefit of priority to U.S. Provisional Application 63/430,800 filed Dec. 7, 2022, which is incorporated herein by reference.

### BACKGROUND

Reservations for various services may be booked using a computing device, such as by accessing a webpage or other reservation interface for a reservation provider. In certain instances, these reservations may require payment to complete booking for the reservation.

### SUMMARY

The present disclosure presents new and innovative systems and methods for processing and routing payment information for reservation computing systems. In some aspects, the techniques described herein relate to a method including: receiving payment information for a reservation; determining a payment token for the reservation based on the payment information; transmitting the payment token to a reservation booking system; receiving, from the reservation booking system, a first application programming interface (API) request to process the reservation with a central reservation service (CRS), wherein the first API request is received at a first API; determining, based on the first API request, a second API request that includes at least a portion of the payment information; and transmitting the second API request to a second API associated with the CRS, wherein the second API request is transmitted from the first API to the second API.

In some aspects, the techniques described herein relate to a method, wherein the payment information is received via a front end user interface for the booking service.

In some aspects, the techniques described herein relate to a method, wherein the payment information is received by a software development kit (SDK) separate from the booking service, wherein the SDK is embedded within a front end of the booking service.

In some aspects, the techniques described herein relate to a method, wherein the payment token is transmitted to a front end of the reservation booking system.

In some aspects, the techniques described herein relate to a method, wherein determining the payment token includes validating the payment information, and wherein transmitting the payment token includes: determining an event based on the validation of the payment information; and transmitting the event to a front end of the reservation booking system.

In some aspects, the techniques described herein relate to a method, wherein the first API request is received from a back end service of the reservation booking system.

In some aspects, the techniques described herein relate to a method, wherein the first API request is received at a first API endpoint of the first API, wherein the first API endpoint is associated with the reservation booking system.

In some aspects, the techniques described herein relate to a method, wherein the first API request includes an external endpoint ID, the payment token, and a request body.

In some aspects, the techniques described herein relate to a method, wherein determining the second API request includes: identifying, at the first API, payment information that corresponds to the payment token from the first API request; and combining the at least a portion of the payment information with the request body to form the second API request.

In some aspects, the techniques described herein relate to a method, wherein the second API request includes authentication information for the second API, reservation information for the reservation, customer information, and at least a portion of the payment information.

In some aspects, the techniques described herein relate to a method, wherein the at least a portion of the payment information included within the second API request is determined based on one or more variables contained within the request body from the first API request.

In some aspects, the techniques described herein relate to a method, wherein the second API request is transmitted to a second API endpoint of the second API, wherein the second API endpoint is predetermined.

In some aspects, the techniques described herein relate to a method, wherein the method further includes: receiving a first API response from the second API, the first API response indicating a result of processing the reservation; determining, based on the first API response, a second API response; and transmitting the second API response to the reservation booking system in response to the first API request.

In some aspects, the techniques described herein relate to a system including: a processor; and a memory storing instructions which, when executed by the processor, cause the processor to: receive payment information for a reservation; determine a payment token for the reservation based on the payment information; transmit the payment token to a reservation booking system; receive, from the reservation booking system, a first application programming interface (API) request to process the reservation with a central reservation service (CRS), wherein the first API request is received at a first API; determine, based on the first API request, a second API request that includes at least a portion of the payment information; and transmit the second API request to a second API associated with the CRS, wherein the second API request is transmitted from the first API to the second API.

In some aspects, the techniques described herein relate to a system, wherein the payment information is received via a front end user interface for the booking service.

In some aspects, the techniques described herein relate to a system, wherein the payment information is received by a software development kit (SDK) separate from the booking service, wherein the SDK is embedded within a front end of the booking service.

In some aspects, the techniques described herein relate to a system, wherein the payment token is transmitted to a front end of the reservation booking system.

In some aspects, the techniques described herein relate to a system, wherein determining the payment token includes validating the payment information, and wherein transmitting the payment token includes: determining an event based on the validation of the payment information; and transmitting the event to a front end of the reservation booking system.

In some aspects, the techniques described herein relate to a system, wherein the first API request is received from a back end service of the reservation booking system.

In some aspects, the techniques described herein relate to a system, wherein the first API request is received at a first API endpoint of the first API, wherein the first API endpoint is associated with the reservation booking system.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system for receiving and processing hotel reservations according to an exemplary embodiment of the present disclosure.

FIG. 2 illustrates a system for validating and handling payment information for hotel reservations according to an exemplary embodiment of the present disclosure.

FIGS. 3A-3C illustrate an event and requests according to exemplary embodiments of the present disclosure.

FIG. 4 illustrates a method for validating and handling payment information for hotel reservations according to an exemplary embodiment of the present disclosure.

FIG. 5 illustrates a user interface for validating and handling payment information for hotel reservations according to an exemplary embodiment of the present disclosure.

FIG. 6 illustrates a computing system according to an exemplary embodiment of the present disclosure.

### DETAILED DESCRIPTION

Various aspects of the present disclosure relate to creating and processing reservations for one or more reservation providers. Processing reservations may include collecting information regarding a reservation from a user and routing that information between one or more reservation computing systems. In certain implementations, collected information may include reservation identifying information (such as a location, date(s), quantity, and/or type of reservation), pricing information, payment information, and the like. For example, certain aspects of the present disclosure describe techniques for receiving and processing payment information in association with reservations. In particular, certain discussed techniques may be performed to receive and process payment information for reservations from booking systems, such as custom booking systems utilized by certain reservation providers. For example, processing payment information may include routing payment information received from a customer (such as routing payment information between a booking system and another system such as a payment system).

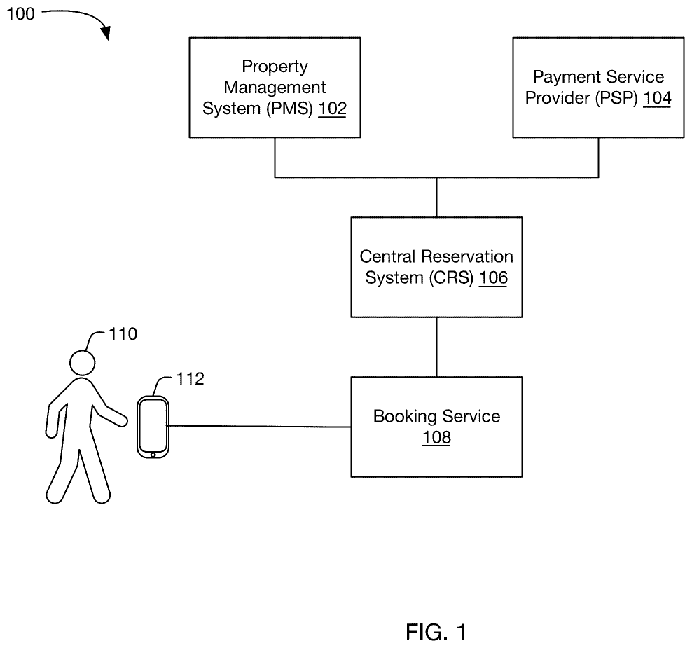

FIG. 1 illustrates a system 100 for receiving and processing hotel reservations according to an exemplary embodiment of the present disclosure. The system 100 includes a property management system (PMS) 102, a payment service provider (PSP) 104, a central reservation system (CRS) 106, a booking service 108, a user device 112, and a user 110. The system 100 may be configured to receive and process reservations on behalf of one or more reservation providers, such as for one or more physical locations (which may be referred to as “properties”) that offer services requiring reservations.

The PMS 102 may maintain centralized information regarding current, past, and future reservations for a reservation provider, such as at a particular location or locations. For example, the PMS 102 may be configured to maintain one or more databases storing information regarding inventory, reservations, customer information, payment status, and the like for one or more properties. The PSP 104 may be configured to receive payment information and to coordinate confirmation and processing of payment information in connection with reservations. For example, the PSP 104 may stage and validate transactions for new or existing associated reservations with one or more payment providers. The booking service 108 may be responsible for receiving and presenting information to users (such as customers) so that the users can create new reservations or modify existing reservations. For example, the booking service 108 may present a front end interface to a user 110 that the user 110 can use to create or modify reservations. The booking service 108 may integrate with one or more other portions of the system 100, such as via back end integrations with the CRS. In such instances, the booking service 108 may communicate with the CRS to receive information to display to a user regarding a reservation (such as dates, locations, pricing, quantity, and amenity information). The CRS 106 may coordinate with the PMS 102 and the PSP 104 based on interactions with customers. For example, the CRS 106 may receive information via the booking service 108 and may communicate with the PSP 104 to process a payment using the received information. The CRS 106 may also communicate with the PMS 102 to update the reservation, such as to create a new reservation within the PMS 102, update a status for an existing reservation, to store payment information in association with an existing reservation, and the like. It should be understood that the depicted and discussed implementations of the system 100 are merely illustrative. Various other implementations may differ, for example by including additional components, by excluding various components, by performing certain functionality with different components from those discussed above, by providing additional functionality, and the like. As one specific example, in certain implementations, the PSP 104 may be configured to communicate directly with the PMS 102 (e.g., to receive payment information and process payments using the payment information). In such instances, the PSP 104 may not be communicatively coupled with the CRS 106.

In certain implementations, certain reservation providers, especially larger operators, may utilize custom booking systems. For example, one or more of the PMS 102, the PSP 104, CRS 106, and the booking service 108 may be custom or customized software for a particular operator. In such instances, this software may provide functionality of particular use to the provider, but may require the operator to maintain it independently, such as by themselves or through a vendor. However, certain aspects of the reservation booking experience change quickly. In particular, payment technologies are quickly developing, which can make it hard to maintain compatibility with various types of payment methods. For example, digital payment providers change rapidly over time, and integrating with these providers requires consistent service updates. As another example, new authentication techniques for payment methods may similarly require frequent platform updates for corresponding systems. This can be particularly cumbersome for booking services 108, which are user-facing. Customers expect reservation providers to integrate with the latest payment methods, and failure to do so can result in failed payments and abandoned sales. Incorporating updated payment information receipt and processing with custom booking services is accordingly labor intensive, but necessary to continue meeting ongoing security, technical, and customer requirements.

One solution to this problem is to extend existing booking services using payment information processing capabilities that can route payment information between booking services (such as custom booking services) and PSPs. In particular, payment information may be received via an SDK that can be integrated within existing interfaces for a booking service. The payment information may be tokenized and securely stored separate from the booking service. The booking service may receive the payment token and may provide reservation information to an API with the payment token. The API may then stage an additional API request based on the received reservation information. For example, the additional API request may be prepared for an API associated with the PSP and may include payment information based on the payment token received from the booking service. The additional API request may then be transmitted to the PSP to process payment for the reservation. In certain implementations, a response may be received from the PSP, and an additional response may be generated and transmitted to the booking service.

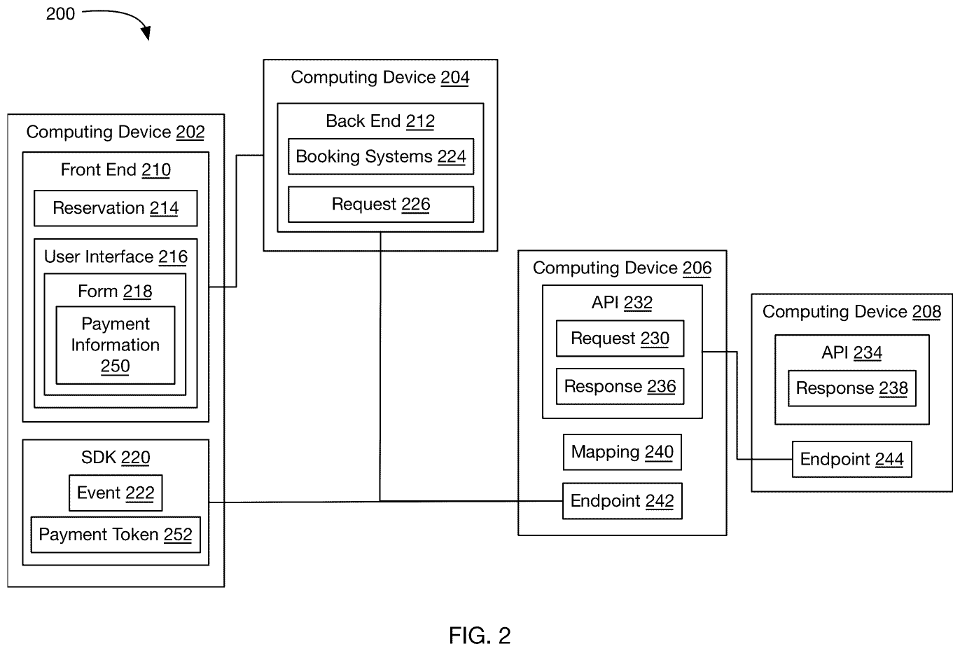

FIG. 2 illustrates a system 200 for validating and handling payment information for reservations according to an exemplary embodiment of the present disclosure. The system 200 includes a computing device 202, a computing device 204, a computing device 206, and a computing device 208. The computing device 202 includes a front end 210, which includes a reservation 214, a user interface 216, and a software development kit (SDK) 220. The user interface 216 includes a form 218, which includes payment information 250. The SDK 220 includes an event 222 and a payment token 252. The computing device 204 includes a back end 212, which includes booking systems 224, a request 226, and a request 228. The computing device 206 includes an API 232, a mapping 240, and an endpoint 242. The API 232 includes a request 230, and a response 236. The computing device 208 includes an API 234 and an endpoint 244. The API 234 includes a response 238.

The computing devices 202, 204 may implement a booking service 108. For example, the front end 210 may be a front end of the booking service 108, such as a user-facing front end of the booking service 108. As another example, the back end 212 may be a back end of the booking service 108, such as by providing back end processing and functionality for the booking service 108 using the booking system 224. The computing device 208 may implement at least a portion of a CRS. For example, the API 324 may be an API for the CRS 106.

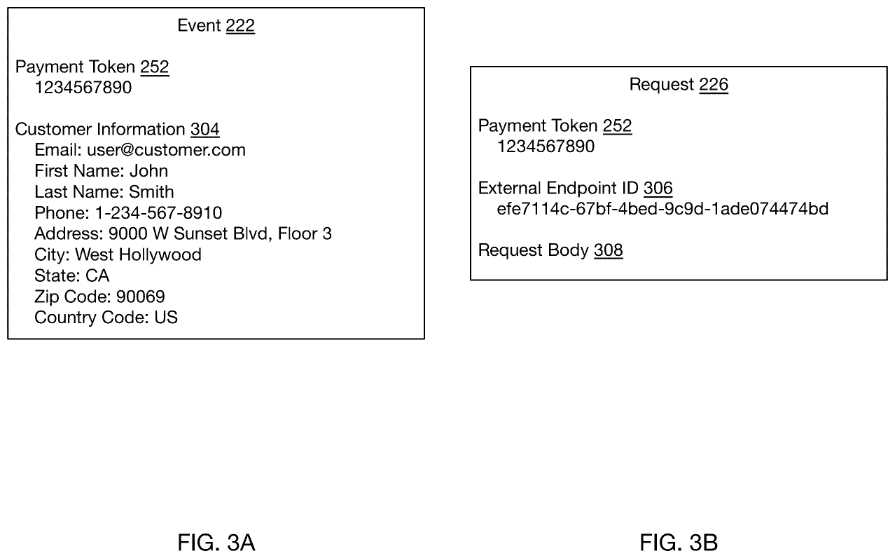

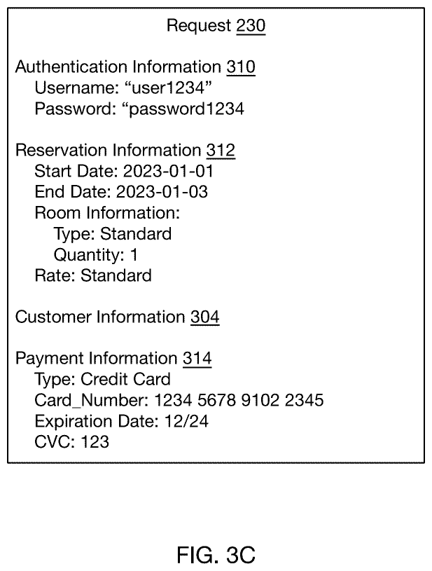

The computing device 202 may be configured to implement the front end 210, which may be accessible by users 110 via user devices 112 to create reservations 214. Reservations 214 may be a pre-paid or otherwise assigned or allocated period of time during which a user (e.g., the user 110) is entitled to use or occupy a particular location, such as exclusively, with other guests, with other parties subject to other reservations. In certain instances, the reservation 214 may be for lodging, such as an overnight stay or room and board in, e.g., a hotel, motel, hostel, and the like. In other instances, the reservation 214 may be for dining in a particular location, such as a bar or restaurant. In further instances, the reservation 214 may be to occupy an event space, such as a wedding venue or other event venue. One skilled in the art will appreciate that the techniques described in the present disclosure may be used with various types of reservations not described above. All such reservations are considered within the scope of the present disclosure. In addition to identifying a location, the reservation 214 may identify additional information, such as amenities or services purchased or included with the reservation, booking requirements for the reservation, price information, and the like. Exemplary reservation information is discussed further below in connection with FIG. 3C.

The computing device 202 may be configured to receive payment information 250 for a reservation 214. The payment information 250 may include any information necessary to complete payment on behalf of the user 110. For example, payment information 250 may include credit card information, a customer name, a billing address, a card verification code (CVC), a digital wallet verification token, and the like. In certain implementations, the payment information 250 may be received via a user interface 216 of the front end 210. For example, the payment information 250 may be received via a form 218 presented via the user interface 216. In certain implementations, the payment information 250 may be received by a software development kit (SDK) 220 separate from the booking service 108. For example, the SDK 220 may provide the form 218, which may be embedded within a front end 210 of the booking service 108. However, the SDK 220 and the form 218 may be provided by an entity separate from the booking service 108 in order to route information outside of the booking service 108 for further processing.

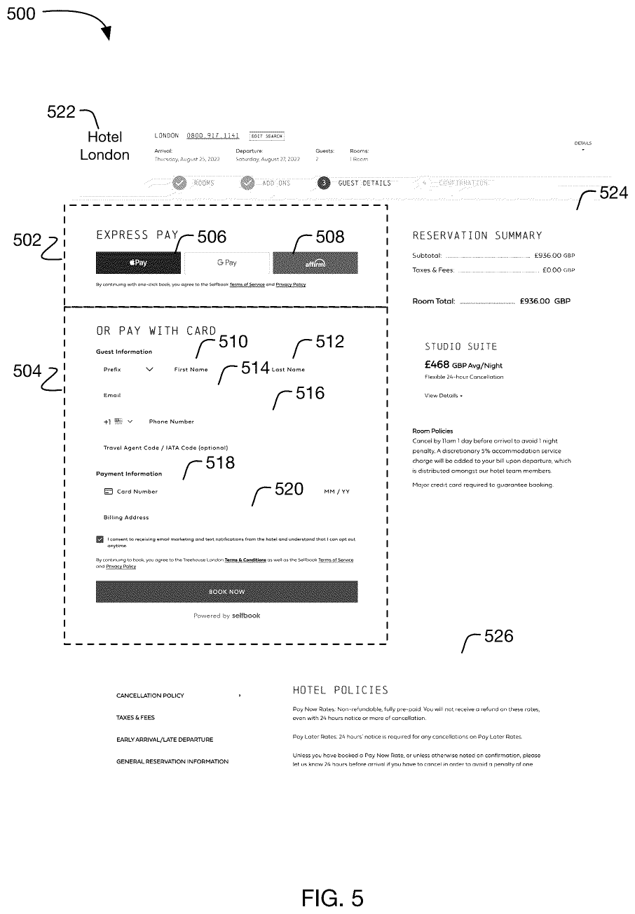

The SDK 220 may provide support for receiving various types of payment information, such as credit card information and/or digital wallet information. In particular, the form 218 may be provided by the SDK 220 and embedded in the user interface 216 to provide payment information validation and storage services for the booking service 108 (e.g., the front end 210 and back end 212 of the booking service 108). In certain implementations, a user 110 may select between one or more digital wallet providers and credit card payment options via the form 218. If the user 110 elects credit card payment, the user 110 may provide credit card information via the form 218. If the user 110 elects digital wallet payments, the user 110 may authenticate with the digital wallet provider via the form 218, which may integrate with one or more authentication APIs for the digital wallet providers. Digital wallet providers may include digital payment providers (such as Apple Pay®, Google Pay®, PayPal®, Samsung Pay®, and the like) financing companies/“Buy Now Pay Later” (BNPL) providers (such as Affirm®, Klarna@, PayPal Pay in 40, and the like). After authenticating with the digital wallet provider, the form 218 may receive payment information 250 that includes a tokenized identifier of the user 110 and the purchase to be processed. User interfaces for receiving payment information are discussed in greater detail below in connection with FIG. 5.

The computing device 202 may be configured to determine a payment token 252 for the reservation 214 based on the payment information 250. In certain implementations, the SDK 220 may be configured to determine the payment token 252. For example, the SDK 220 may validate the received payment information 250 and may generate a payment token 252 containing a unique identifier associated with the reservation 214 if the verification is successful. In certain instances, the SDK 220 may communicate with the API 232 to perform payment information 250 validation. For example, the SDK 220 may transmit the payment information 250 to the API 232 and may receive the payment token 252 in response if the API 232 is able to validate the payment information 250. In further instances, the SDK 220 may communicate with another API (not depicted) to perform payment information 250 validation. For example, the SDK 220 may transmit an API request to the API to make a microauthorization using the received payment information 250. A response may be received from the API that includes the payment token 252, a fraud risk evaluation for the payment information, and combinations thereof. In certain implementations, validating the payment information 250 may include storing the payment token 252 and the payment information 250 for future use. For example, the SDK 220 may transmit the payment information 250 and/or the payment token 252 to the computing device 206 (such as to the API 232) for future use.

The computing device 202 may be configured to transmit the payment token 252 to a booking service 108. In certain implementations, the payment token 252 may be transmitted to the front end 210 of the booking service 108. For example, transmitting the payment token 252 may include determining an event 222 based on the validation of the payment information 250 and transmitting the event 222 to the front end. In certain implementations, events 222 may include alerts, notifications, or other programmatic notices generated in response to one or more detected criteria. For example, the events 222 may be generated as HTTP events 222 broadcast by the SDK 220 or a portion of the SDK 220. In certain implementations, in particular, the SDK 220 may include an event listener that may be added to the front end 210 during installation and configuration of the SDK 220 with the front end 210. The front end 210 of the booking service 108 may then receive the events 222 via the event listener, which may provide a web socket or other mechanism for receiving events broadcast by the SDK 220. In certain implementations, different types of events 222 may be generated based on different results for validating the received payment information 250. For example, the SDK 220 may generate a success event 222 if the payment information 250 is successfully validated and may generate a failure event if the payment information 250 is unsuccessfully validated. In certain implementations, the success event 222 may contain the payment token 252 along with other information. For example, the success event 222 may be generated to additionally include customer information 304 (e.g., when the information is received by the SDK 220 from the user 110 or front end 210 for payment verification). In particular, and referring to FIG. 3A, the event 222 may include the payment token 252 and customer information 304. The customer information 304 may include identifying information for the user 110 that booked the reservation 214, a user 110 who is paying for the reservation 214, and/or a user 110 that will utilize the reservation 214. For example, as depicted, the customer information 304 may include an email address for the user 110, a first/last name for the user 110, a phone number for the user 110, an address for the user 110, a city/state/zip code for the user 110, and/or a country code for the user 110. Failure events may include an error code or other indication of why validation of the payment information 250 failed. For example, the failure event include one or more error codes received from a payment validation service (such as a payment validation service of the API 232 and/or another API). In response to receiving the error event 222, the front end 210 may be configurable to present an error message to the user 110.

The front end 210 may be configured to transmit reservation information to the back end 212. For example, the back end 212 may contain various booking systems 224 configured to provided services for the booking service 108, such as creating a new reservation, communicating with the CRS 106 to store information regarding a new reservation or retrieve information regarding a previous reservation, and the like. In certain implementations, the front end 210 may be configured to transmit the reservation 214 and the payment token 252 to the back end 212. In particular, the front end 210 may transmit this information to the back end 212 with functionality that is separate from the SDK 220. For example, the booking service 108 may be provided by a separate entity from the SDK 220, and communication between the front end 210 and the back end 212 of the booking service 108 may thus be coordinated separate from the SDK 220, such as via APIs or internal communication mechanisms of the booking service 108. In certain instances, the reservation 214 and the payment token 252 may be transmitted together. For example, the front end 210 may transmit the reservation 214 and the payment token 252 to the back end 212 after receiving a success event 222 that contains the payment token 252. In other instances, the reservation 214 and the payment token 252 may be transmitted separately. For example, the front end 210 may initially transmit the reservation 214 after the reservation 214 is created by the user 110 and may later transmit the payment token 252 after receiving the 252 from the SDK 220.

The computing device 206 may be configured to receive, from the booking service 108, a request 226 to process the reservation 214 with a central reservation 214 service (CRS), such as the CRS 106. The request 226 may be an application programming interface (API) request for an API implemented by the computing device 206, such as the API 232. In certain implementations, the request 226 may be received from the back end 212 of the booking service 108. For example, after receiving the reservation 214 and/or the payment token 252 from the front end 210, the back end 212 may prepare and transmit the request 226.

In certain implementations, the request 226 may be received at an API 232 endpoint 242 of the API 232. For example, the API 232 may be accessible via multiple endpoints (such as public endpoints), and the back end 212 may be assigned to communicate with the API 232 via the endpoint 242. For example, the API 232 endpoint 242 may be associated with at least one of the reservation 214 and the booking service 108. In certain implementations, separate endpoints 242 may be associated with particular properties, particular locations, particular groups of properties or locations, particular operators (such as hotel operators, restaurant operators), the booking service 108, and combinations thereof. In certain implementations, when enrolling, a provider associated with the booking service 108 may be assigned a corresponding API endpoint 242 to which requests 226 from the provider should be transmitted. Certain endpoints 242 for the API 232 may be private to particular individual entities (such as individual operators or booking services 108). Additional or alternative endpoints 242 may be publicly accessible and/or may be accessible by multiple separate entities.

In certain implementations, the request 226 may include the payment token 252 and/or an identifier of the reservation 214. In further implementations, the request 226 may include information to authenticate the request 226 and/or additional information regarding the reservation 214. In particular, and referring to FIG. 3B, the request 226 may include a payment token 252, an external endpoint ID 306, and a request body 308. The external endpoint ID 306 may be used to verify that the request was actually send from the back end 212. For example, the external endpoint ID 306 may be provided to the back end (or a user thereof) during enrollment of the booking service 108 with the payment handling services offered by the SDK 220 and the API 232. A private API key may be included with the request 226, such as by including the API key in a username field for the 226. In particular, the request 226 may be transmitted as an HTTP POST request, and the private API key may be included in a username field of the HTTP POST request. The private API key may then be compared with the external endpoint ID 306 (or the endpoint 242) to verify that the request 226 was received from the back end 212 and that processing should proceed. The request body 308 may provide all or part of the contents of a request that should be transmitted to the CRS 106. For example, the request body 308 may include all or part of the contents of a request 230 for the API 232 to transmit to an API 234 associated with the CRS 106. For example, the request body 308 may include authentication information for the API 234, reservation information for the reservation 214, customer information for the reservation 214, payment information for processing payment for the reservation 214, requests for the API 232 to add specific types of payment information, and combinations thereof.

The computing device 206 may be configured to determine, based on the request 226 a second request 230. The request 230 may be an API request for an API associated with the CRS 106, such as the API 234. The request 230 may include at least a portion of the payment information 250. The API 234 may be predetermined. For example, the API 234 may have been previously selected or identified as corresponding the booking service 108 (such as the front end 210 or the back end 212 of the booking service 108) during enrollment of the booking service 108 with the API 232. Endpoints 244 for the API 234 (such as URLs for the endpoints 244) may similarly be predefined (such as during enrollment). In certain instances, the API 234 may be selected based on the external endpoint ID 306 included within the request 228. For example, the API 232 may store a mapping 240 between API keys, endpoint IDs, and associated third-party APIs for future use in validating and processing received requests 226.

In certain implementations, determining the request 230 may include identifying payment information 250 that corresponds to the payment token 252 included in the request 226 and combining at least a portion of the payment information 250 with the request body 308 to determine the request 230. For example, the request 230 may be generated to enable the API 234 to process payment and complete a booking procedure for the reservation 214. The request body 308 may include requests for the API 232 to add specific types of payment information 250 to the request 230. Because the form 218 and the SDK 220 received the payment information 250, the booking service 108 may not have access to the contents of the payment information 250 and may only have the payment token 252. Accordingly, the request body 308 may contain flags, variables, or other indications that the API 232 is configured to replace with corresponding information from the payment information 250. These requests may include a credit card number, an expiration date (expiration month, expiration year), CVV number, a digital wallet validation token, and combinations thereof. After receiving the request 226, the API 232 may identify such requests and replace them with corresponding values from the payment information 250. In particular, the API 232 may identify, based on the payment token 252, corresponding payment information 250 for the request 226 and may replace the requests for specific payment information values from the request body 308 with the corresponding values contained within the payment information 250 when generating the request 230. In certain implementations, based on the request body 308, the request 230 may also include authentication information for the API 234, reservation information for the reservation 214, customer information for the reservation 214, and combinations thereof. For example, the contents of the request body 308 may be copied or otherwise inserted into a body of the request 230. In particular, and referring to FIG. 3C, the request 230 may include authentication information 310, reservation information 312, customer information 304, and payment information 314. The authentication information 310 may be used to authenticate with the API 234 and may include a username, password, API key, and combinations thereof. The reservation information 312 may include information necessary to book and finalize the reservation 214 with the CRS 106. For example, the reservation information 312 may include a start date for the reservation 214, an end date for the reservation 214, room information for the reservation 214 (such as a room type and a room quantity), rate information for the reservation 214 (such as a rate class or specific rate cost), and combinations thereof. The customer information 304 may be similar to the customer information 304 included within the event 222. The payment information 314 may include information necessary for the CRS 106 to process payment to complete processing and booking of the reservation 214. For example, the payment information 314 may include a type of payment selected (such as selected within the form 218, a card number for a credit card, an expiration date for the credit card, a CVC for the credit card, a verification token for a digital payment provider, an identifier of the digital payment provider, and the like. As explained above, the API 232 may generate the payment information 314 by replacing one or more flags or other requests within the request body 308 with corresponding data values from the payment information 250 for the reservation 214.

The computing device 206 may be configured to transmit the request 230 to an API 234 associated with the CRS 106. In particular, the request 230 may be transmitted from the API 232 to the API 234. In certain implementations, the request 230 may be transmitted to an endpoint 244 of API 234, which may be predetermined. In certain implementations, the endpoint 344 may be determined based on at least a portion of the request 226. For example, as explained above, the API 232 may identify the endpoint 244 based on the external endpoint ID 306 and the mapping 240.

After transmitting the request 230, the computing device 206 may receive a response 238 from the API 234. The response may indicate a result of processing the reservation 214 based on the request 230. For example, the CRS 106 may process the request 230 based on the information contained within the request 230 to book the reservation 214 and may generate the response 238 based on the results of the processing. Accordingly, based on the configuration of the CRS 106, the response 238 may contain an indication of the success or failure of processing the reservation 214. For example, the response 238 may contain a success indication and may include an identifier of the finalized transaction or booking of the reservation 214. If the processing failed, the response 238 may contain a failure code or error code indicating why or how the processing failed. The API 232 may be configured to generate a response 236 based on the response 238. For example, the API 232 may forward a copy of the response 238 to the back end 212 as the response 236. Additionally or alternatively, the API 232 may add information to the response 238 or modify the contents of the response 238 to generate the response 236. The response 236 may then be transmitted to the computing device 204. For example, the response 236 may be transmitted as an HTTP response to the request 230.

The computing devices 202, 204, 206, 208 may each be implemented by one or more computing systems (such as the computer system 600). In certain implementations, one or more of the computing devices 202, 204, 206, 208 may be implemented as a single computing system. For example, the computing devices 202, 204 may be implemented as a single computing device. In certain implementations one or more of the computing devices 202, 204, 206, 208 may be implemented within one or more distributed computing environments (such as cloud computing environments). For example, the computing devices 202, 204 may be implemented within a first distributed computing environment, the computing device 206 may be implemented within a second distributed computing environment, and the computing device 208 may be implemented within a third distributed computing environment. The computing devices 202, 204, 206, 208 may also include processors and memories (not depicted). The processors and the memories may implement one or more aspects of the computing devices 202, 204, 206, 208. For example, the memories may store instructions which, when executed by the processors, may cause the processors to perform one or more operational features of the computing devices 202, 204, 206, 208. The processors may be implemented as one or more central processing units (CPUs), field programmable gate arrays (FPGAs), and/or graphics processing units (GPUs) configured to execute instructions stored on the memories. Additionally, the computing devices 202, 204, 206, 208 may be configured to communicate using a network. For example, the computing devices 202, 204, 206, 208 may communicate with the network using one or more wired network interfaces (e.g., Ethernet interfaces) and/or wireless network interfaces (e.g., Wi-Fi®, Bluetooth®, and/or cellular data interfaces). In certain instances, the network may be implemented as a local network (e.g., a local area network), a virtual private network, L1, and/or a global network (e.g., the Internet).

In certain implementations, the above-described techniques may enable the secure receipt and processing of payment information regarding reservations between booking services (such as custom booking services) and corresponding PSPs. In particular, by using forms that can be integrated within booking services via simple SDK function calls, these techniques can easily integrate into the booking services that properties already use, which enables the use of both custom booking services (which can improve flexibility in booking capabilities and appearances) and responsive, cutting-edge payment capture and processing. In certain implementations, this may be enabled by the specific architectural design of the system. For example, by operating outside of the booking service itself using separate APIs, the system enables integration of new payment processing techniques without having to make significant corresponding updates to the booking service to receive and process associated payment information. Furthermore, as explained further below, one or more components of forms utilized by the system may be customizable to maintain a consistent look and feel with other interfaces provided by the booking service.

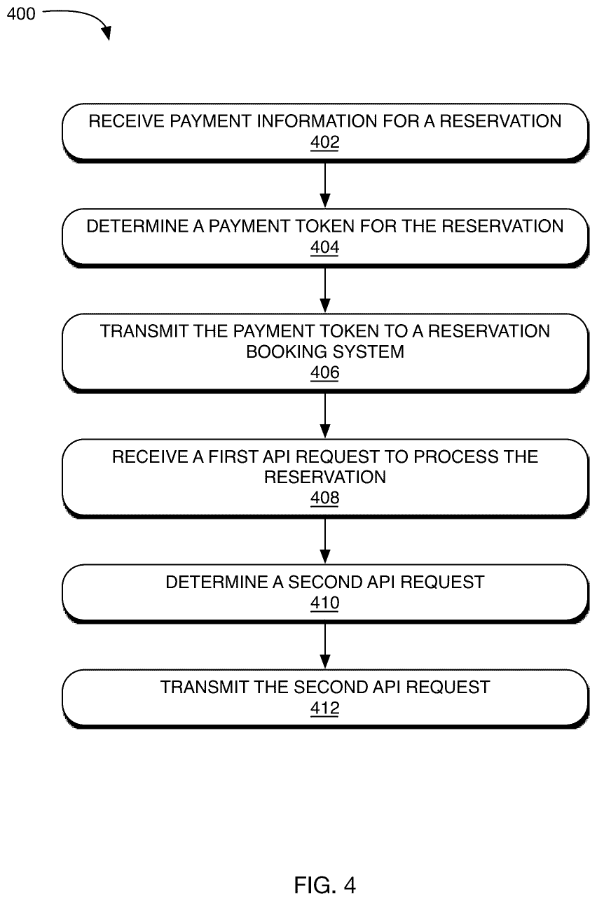

FIG. 4 illustrates a method 400 for validating and handling payment information for hotel reservations according to an exemplary embodiment of the present disclosure. The method 400 may be implemented on a computer system, such as the system 200. For example, the method 400 may be implemented by the computing devices 202, 204, 206, 208. In particular, the method 400 may be implemented by the computing devices 202, 206. The method 400 may also be implemented by a set of instructions stored on a computer readable medium that, when executed by a processor, cause the computing device to perform the method 400. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks may be optional.

The method 400 includes receiving payment information for a reservation (block 402). For example, the computing device 202 may receive payment information 250 for a reservation 214. In certain implementations, the payment information 250 may be received by an SDK 220 embedded within a front end 210 of a booking service 108. For example, the payment information 250 may be received by a form 218 provided by the SDK 220 and accessible via a user interface 216 of the front end 210. The payment information 250 may include information regarding a digital wallet payment and/or a credit card payment

The method 400 includes determining a payment token for the reservation based on the payment information (block 404). For example, the computing device 202 may determine a payment token 252 for the reservation 214 based on the payment information 250. In certain implementations, the SDK 220 may be configured to determine the payment token 252. For example, the SDK 220 may validate the payment information 250 and may generate the payment token 252 if the validation is successful. As another example, the SDK 220 may request validation of the payment information 250 from a payment validation service (such as the API 232 or another API) and may receive the payment token 252 from the payment validation service if the validation is successful. As explained further above, the payment information 250 and the payment token 252 may be stored for future use, such as future use by the API 232.

The method 400 includes transmitting the payment token to a booking service (block 406). For example, the computing device 202 may transmit the payment token 252 to a booking service 108. In certain implementations, the payment token 252 may be transmitted to a front end 210 of the booking service 108. For example, the SDK 220 may transmit the payment token 252 within an event 222 to the front end 210. The front end 210 may receive the event 222 at an event listener, which may be provided by the SDK 220.

The method 400 includes receiving a first API request to process the reservation (block 408). For example, the computing device 206 may receive, from the booking service 108, a first API request 226 to process the reservation 214 with a CRS 106. The request 226 may be received at an API 232, such as at an endpoint 244 of the API 232. The endpoint 244 may be predefined and may correspond to the booking service 108. In certain implementations, the request 226 may be received from the back end 212 of the booking service 108, which may execute on a separate computing device 204 from the computing devices 202 executing the front end 210.

The method 400 includes determining a second API request (block 410). For example, the computing device 206 may determine, based on the request 226, a second API request 230. The request 230 may include at least a portion of the payment information 250, which may be replaced within a request body 308 of the request 226 based on fields or other requests included within the request body 308.

The method 400 includes transmitting the second API request (block 412). For example, the computing device 206 may transmit the request 230 to a second API 234. The second API 234 may be associated with the CRS 106. The request 230 may be transmitted from the API 232 to the API 234. In certain implementations, the request 230 may be transmitted to an endpoint 344 of the API 234, which may be predetermined. In certain implementations, the endpoint 344 may be determined based on at least a portion of the request 226. For example, the 244 may be identified by an external endpoint ID 306 included within the request 226.

FIG. 5 illustrates a user interface (UI) 500 for validating and handling payment information for hotel reservations according to an exemplary embodiment of the present disclosure. The UI 500 includes a digital wallet portion 502, a credit card portion 504, hotel branding information 522, reservation summary information 524, and hotel policy information 526. The UI 500 may be displayed on a display of a computing device, such as a smartphone, table, laptop, personal computer, and the like. In certain implementations, the UI 500 may be displayed as a webpage via a web browser executing on the computing device. For example, the UI 500 may be a webpage accessible via a reservation booking flow provided by a reservation provider, such as a hotel, restaurant, event space provider, and the like. In certain instances, other portions of the reservation provider may use a booking service, such as a custom booking service, and the UI 500 may be part of a reservation flow provided by the booking service.

Together, the digital wallet portion 502 and the credit card portion 504 may constitute a form (such as the form 218) provided by the SDK 220. In certain implementations, the form may only include one of the digital wallet portion 502 or the credit card portion 504. For example, in certain implementations a form may include the digital wallet portion 502 and may exclude the credit card portion 504. As another example, a form may include the credit card portion 504 and may exclude the digital wallet portion 502. The form may be provided by a separate entity from the booking engine. For example, the form may be a form 218 presented within a webpage provided by a booking service 108 that is separate from the API 232 utilized by the form 218, as described above. For example, the form may be integrated into the webpage via an SDK 220, such as via a script tag (e.g., HTML tag) within source code for the webpage. Various aspects, such as a public API key, may be included within the initiating code for the form within the webpage.

The digital wallet portion 502 includes options 506, 508. The options 506, 508 may be clicked, tapped, or otherwise selected by a user to initiate authentication with one or more digital wallet providers. For example, the option 506 may initiate authentication to process payment via Apple Pay® and the option 508 may initiate authentication to process payment using a BNPL service, such as Affirm®.

The credit card portion 504 includes fields 510, 512, 514, 516, 518, 520. The fields 510, 512, 514, 516, 518, 520 may be used to receive information necessary to initiate and process a credit card payment. For example, the fields 510, 512 may be used to receive a user's name, the field 514 may be used to receive a user's email address, the field 516 may be used to receive a user's phone number, the field 518 may be used to receive a user's credit card number, and the field 520 may be used to receive a user's billing address. Other information may be received by various other fields, some of which may be depicted and not numbered, and others of which may not be depicted.

Various aspects of the digital wallet portion 502 and the credit card portion 504 may be configurable within the UI 500. For example, as noted above, the UI 500 may be configured to exclude one of the digital wallet portion 502 and the credit card portion 504. In such instances, the SDK 220 may omit corresponding functions. For example, if the credit card portion 504 is excluded, the SDK 220 may be updated to remove function libraries used to receive and process credit card information. As another example, if the digital wallet portion 502 is excluded, the SDK 220 may be updated to remove function libraries used to interact with digital wallet providers to authenticate the user. Furthermore, in certain implementations, the digital wallet portion 502 may be configurable to exclude one or more digital wallet providers. For example, one or more configurable tags (e.g., HTML tags) or other settings (e.g., SDK 220 configuration settings) for the digital wallet portion 502 may be set to exclude BNPL providers. In such instances, the option 508 may be excluded from the digital wallet portion 502, and one or more functions used to authenticate users and process payments with those providers may be removed from the SDK 220.

In certain implementations, the visual appearance of one or more portions of the UI 500, such as one or more portions of the digital wallet portion 502 and the credit card portion 504 may be customizable, such as by changing a font, text size, text color, background color, element size, element color, displayed wording, text arrangement, and the like for one or more elements of the UI 500. For example, corresponding appearance settings or attributes for different elements of the digital wallet portion 502 and the credit card portion 504, such as the options 506, 508, the fields 510, 512, 514, 516, 518, 520, and combinations thereof, may be configurable to adjust one or more visual aspects. For example, various visual elements (e.g., text size, font, text color, element color) may be configurable to visually align with branding or other marketing practices for the reservation provider. Visual customization may be controlled via the SDK 220, such as by setting values for one or more corresponding attributes within the SDK 220.

Other portions of the UI 500 may be provided separate from the functionality of the form (e.g., the functionality of the digital wallet portion 502, the credit card portion 504, and combinations thereof). For example, the reservation summary information 524 may be provided by the booking service 108 and may display information regarding the reservation booked by the user, including a type of room, a type of rate, and cost information as depicted. Other portions of the UI 500, such as the hotel branding information 522 and the hotel policy information 526, may be provided by the reservation provider. The hotel branding information 522 may provide branding information to indicate the property at which a reservation is being booked. The reservation summary information 524 may include relevant policies for the reservation, such as cancellation policies, tax policies, early arrival/late departure policies, and the like.

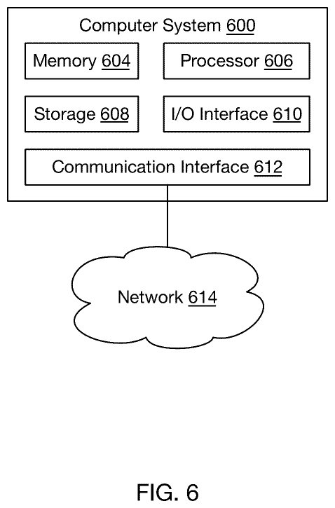

FIG. 6 illustrates an example computer system 600 that may be utilized to implement one or more of the devices and/or components discussed herein, such as the computing devices 202, 204, 206, 208, the PMS 102, the PSP 104, the CRS 106, the booking service 108, and the user device 112. In particular embodiments, one or more computer systems 600 perform one or more steps of one or more methods described or illustrated herein. In particular embodiments, one or more computer systems 600 provide the functionalities described or illustrated herein. In particular embodiments, software running on one or more computer systems 600 performs one or more steps of one or more methods described or illustrated herein or provides the functionalities described or illustrated herein. Particular embodiments include one or more portions of one or more computer systems 600. Herein, a reference to a computer system may encompass a computing device, and vice versa, where appropriate. Moreover, a reference to a computer system may encompass one or more computer systems, where appropriate.

This disclosure contemplates any suitable number of computer systems 600. This disclosure contemplates the computer system 600 taking any suitable physical form. As example and not by way of limitation, the computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 606, memory 604, storage 608, an input/output (I/O) interface 610, and a communication interface 612. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 606 includes hardware for executing instructions, such as those making up a computer program. As an example and not by way of limitation, to execute instructions, the processor 606 may retrieve (or fetch) the instructions from an internal register, an internal cache, memory 604, or storage 608; decode and execute the instructions; and then write one or more results to an internal register, internal cache, memory 604, or storage 608. In particular embodiments, the processor 606 may include one or more internal caches for data, instructions, or addresses. This disclosure contemplates the processor 606 including any suitable number of any suitable internal caches, where appropriate. As an example and not by way of limitation, the processor 606 may include one or more instruction caches, one or more data caches, and one or more translation lookaside buffers (TLBs). Instructions in the instruction caches may be copies of instructions in memory 604 or storage 608, and the instruction caches may speed up retrieval of those instructions by the processor 606. Data in the data caches may be copies of data in memory 604 or storage 608 that are to be operated on by computer instructions; the results of previous instructions executed by the processor 606 that are accessible to subsequent instructions or for writing to memory 604 or storage 608; or any other suitable data. The data caches may speed up read or write operations by the processor 606. The TLBs may speed up virtual-address translation for the processor 606. In particular embodiments, processor 606 may include one or more internal registers for data, instructions, or addresses. This disclosure contemplates the processor 606 including any suitable number of any suitable internal registers, where appropriate. Where appropriate, the processor 606 may include one or more arithmetic logic units (ALUs), be a multi-core processor, or include one or more processors 606. Although this disclosure describes and illustrates a particular processor, this disclosure contemplates any suitable processor.

In particular embodiments, the memory 604 includes main memory for storing instructions for the processor 606 to execute or data for processor 606 to operate on. As an example, and not by way of limitation, computer system 600 may load instructions from storage 608 or another source (such as another computer system 600) to the memory 604. The processor 606 may then load the instructions from the memory 604 to an internal register or internal cache. To execute the instructions, the processor 606 may retrieve the instructions from the internal register or internal cache and decode them. During or after execution of the instructions, the processor 606 may write one or more results (which may be intermediate or final results) to the internal register or internal cache. The processor 606 may then write one or more of those results to the memory 604. In particular embodiments, the processor 606 executes only instructions in one or more internal registers or internal caches or in memory 604 (as opposed to storage 608 or elsewhere) and operates only on data in one or more internal registers or internal caches or in memory 604 (as opposed to storage 608 or elsewhere). One or more memory buses (which may each include an address bus and a data bus) may couple the processor 606 to the memory 604. The bus may include one or more memory buses, as described in further detail below. In particular embodiments, one or more memory management units (MMUs) reside between the processor 606 and memory 604 and facilitate accesses to the memory 604 requested by the processor 606. In particular embodiments, the memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory implementations, this disclosure contemplates any suitable memory implementation.

In particular embodiments, the storage 608 includes mass storage for data or instructions. As an example and not by way of limitation, the storage 608 may include a hard disk drive (HDD), a floppy disk drive, flash memory, an optical disc, a magneto-optical disc, magnetic tape, or a Universal Serial Bus (USB) drive or a combination of two or more of these. The storage 608 may include removable or non-removable (or fixed) media, where appropriate. The storage 608 may be internal or external to computer system 600, where appropriate. In particular embodiments, the storage 608 is non-volatile, solid-state memory. In particular embodiments, the storage 608 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. The storage 608 may include one or more storage control units facilitating communication between processor 606 and storage 608, where appropriate. Where appropriate, the storage 608 may include one or more storages 608. Although this disclosure describes and illustrates particular storage, this disclosure contemplates any suitable storage.

In particular embodiments, the I/O Interface 610 includes hardware, software, or both, providing one or more interfaces for communication between computer system 600 and one or more I/O devices. The computer system 600 may include one or more of these I/O devices, where appropriate. One or more of these I/O devices may enable communication between a person (i.e., a user) and computer system 600. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 610 may include one or more device or software drivers enabling processor 606 to drive one or more of these I/O devices. The I/O interface 610 may include one or more I/O interfaces 610, where appropriate. Although this disclosure describes and illustrates a particular I/O interface, this disclosure contemplates any suitable I/O interface or combination of I/O interfaces.

In particular embodiments, communication interface 612 includes hardware, software, or both providing one or more interfaces for communication (such as, for example, packet-based communication) between computer system 600 and one or more other computer systems 600 or one or more networks 614. As an example and not by way of limitation, communication interface 612 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 614 and any suitable communication interface 612 for the network 614. As an example and not by way of limitation, the network 614 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 600 may include any suitable communication interface 612 for any of these networks, where appropriate. Communication interface 612 may include one or more communication interfaces 612, where appropriate. Although this disclosure describes and illustrates a particular communication interface implementations, this disclosure contemplates any suitable communication interface implementation.

The computer system 602 may also include a bus. The bus may include hardware, software, or both and may communicatively couple the components of the computer system 600 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCle) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving payment information for a reservation;
determining a payment token for the reservation based on the payment information;
transmitting the payment token to a reservation booking system;
receiving, from the reservation booking system, a first application programming interface (API) request to process the reservation with a central reservation service (CRS), wherein the first API request is received at a first API;
determining, based on the first API request, a second API request that includes at least a portion of the payment information; and
transmitting the second API request to a second API associated with the CRS, wherein the second API request is transmitted from the first API to the second API.

2. The method of claim 1, wherein the payment information is received via a front end user interface for the booking service.

3. The method of claim 2, wherein the payment information is received by a software development kit (SDK) separate from the booking service, wherein the SDK is embedded within a front end of the booking service.

4. The method of claim 1, wherein the payment token is transmitted to a front end of the reservation booking system.

5. The method of claim 4, wherein determining the payment token includes validating the payment information, and wherein transmitting the payment token comprises:
determining an event based on the validation of the payment information; and
transmitting the event to a front end of the reservation booking system.

6. The method of claim 5, wherein the first API request is received from a back end service of the reservation booking system.

7. The method of claim 1, wherein the first API request is received at a first API endpoint of the first API, wherein the first API endpoint is associated with the reservation booking system.

8. The method of claim 1, wherein the first API request includes an external endpoint ID, the payment token, and a request body.

9. The method of claim 8, wherein determining the second API request includes:
identifying, at the first API, payment information that corresponds to the payment token from the first API request; and
combining the at least a portion of the payment information with the request body to form the second API request.

10. The method of claim 8, wherein the second API request includes authentication information for the second API, reservation information for the reservation, customer information, and at least a portion of the payment information.

11. The method of claim 10, wherein the at least a portion of the payment information included within the second API request is determined based on one or more variables contained within the request body from the first API request.

12. The method of claim 1, wherein the second API request is transmitted to a second API endpoint of the second API, wherein the second API endpoint is predetermined.

13. The method of claim 1, wherein the method further comprises:
receiving a first API response from the second API, the first API response indicating a result of processing the reservation;
determining, based on the first API response, a second API response; and
transmitting the second API response to the reservation booking system in response to the first API request.

14. A system comprising:
a processor; and
a memory storing instructions which, when executed by the processor, cause the processor to:
receive payment information for a reservation;
determine a payment token for the reservation based on the payment information;
transmit the payment token to a reservation booking system;
receive, from the reservation booking system, a first application programming interface (API) request to process the reservation with a central reservation service (CRS), wherein the first API request is received at a first API;
determine, based on the first API request, a second API request that includes at least a portion of the payment information; and
transmit the second API request to a second API associated with the CRS, wherein the second API request is transmitted from the first API to the second API.

15. The system of claim 14, wherein the payment information is received via a front end user interface for the booking service.

16. The system of claim 15, wherein the payment information is received by a software development kit (SDK) separate from the booking service, wherein the SDK is embedded within a front end of the booking service.

17. The system of claim 14, wherein the payment token is transmitted to a front end of the reservation booking system.

18. The system of claim 17, wherein determining the payment token includes validating the payment information, and wherein transmitting the payment token comprises:
determining an event based on the validation of the payment information; and
transmitting the event to a front end of the reservation booking system.

19. The system of claim 18, wherein the first API request is received from a back end service of the reservation booking system.

20. The system of claim 14, wherein the first API request is received at a first API endpoint of the first API, wherein the first API endpoint is associated with the reservation booking system.
